(19) United States
(12) Patent Application Publication
(10) Pub. No.: US 2015/0100914 A1
(43) Pub. Date: Apr. 9, 2015

(54) GESTURES FOR MULTIPLE WINDOW OPERATION

(71) Applicant: Samsung Electronics Co., Ltd., Suwon-si (KR)

(72) Inventor: Haihui GUAN, Cupertino, CA (US)

(73) Assignee: Samsung Electronics Co., Ltd., Suwon-si (KR)

(21) Appl. No.: 14/046,580

(22) Filed: Oct. 4, 2013

(51) Int. Cl. G06F 3/0488; G06F 3/0481

(52) U.S. Cl. CPC G06F 3/04886; G06F 3/0481
USPC 715/781

(57) ABSTRACT

A method for creating multiple windows on a touch screen display of an electronic device is provided. The method includes detecting a multi-point touch event on an edge of the touch screen display, the multi-point touch event including the simultaneous contact of the touch screen display at two or more points.

### TECHNICAL FIELD

The present disclosure relates to using gestures in a multiple window environment of a touch sensitive device. More particularly, the present disclosure relates to using intuitive gestures to create, reposition, resize and close multiple windows on the display of the touch sensitive device.

### BACKGROUND

Electronic devices have been developed to simultaneously process a variety of functions, such as communications, multimedia, and the like. In this regard, there has been a demand for electronic devices to become thinner, lighter and simpler to enhance portability and to make a user experience more convenient.

To improve the user experience, many electronic devices have been developed to include a touch screen having a touch panel and a display panel that are integrally formed with each other and used as the display unit thereof. Such touch screens have been designed to deliver display information to the user, as well as receive input from user interface commands. Likewise, many electronic devices have been designed to detect intuitive gestures in order to simplify and to enhance user interaction with the device. Such gestures may include a user's body part, such as a finger or a hand, and may also include other devices or objects, such as a stylus, or the like.

For example, a system has been developed that compares finger arrangements at the beginning of a multi-touch gesture and distinguishes between neutral and spread-hand arrangements. Likewise, there have been systems developed that detect various drag, flick, and pinch gestures, including gestures to drag and move items around in the user interface.

In some electronic devices, the selection of a user interface not currently exposed on a display has been made possible through the detection of a gesture initiated at the edge of the display. Such a gesture, initiated at the edge of a display, is commonly known as a swipe gesture.

Nonetheless, despite these advances, electronic devices have not been developed to adequately address the unique demands of a multiple window environment on a display thereof.

Therefore, a need exists for a method and an apparatus that allows a user to employ intuitive gestures for creating, repositioning, resizing and closing one or more windows of a multiple window environment on a touch sensitive device.

The above information is presented as background information only to assist with an understanding of the present disclosure. No determination has been made, and no assertion is made, as to whether any of the above might be applicable as prior art with regard to the present disclosure.

### SUMMARY

Aspects of the present disclosure are to address at least the above-mentioned problems and/or disadvantages and to provide at least the advantages described below. Accordingly, an aspect of the present disclosure is to provide an apparatus and method for controlling one or more windows of a multiple window environment on a touch sensitive device.

In accordance with an aspect of the present disclosure, a method for creating multiple windows on a touch screen display of an electronic device is provided. The method includes detecting a multi-point touch event on an edge of the touch screen display, the multi-point touch event including the simultaneous contact of the touch screen display at two or more points.

In accordance with another aspect of the present disclosure, an electronic device capable of displaying multiple windows on a touch screen display thereof is provided. The electronic device includes a touch screen display capable of displaying multiple windows, and a controller configured to detect a multi-point touch event on an edge of the touch screen display, the multi-point touch event including the simultaneous contact of the touch screen display at two or more points

Other aspects, advantages, and salient features of the disclosure will become apparent to those skilled in the art from the following detailed description, which, taken in conjunction with the annexed drawings, discloses various embodiments of the present disclosure.

### BRIEF DESCRIPTION OF THE DRAWINGS

The above and other aspects, features, and advantages of certain embodiments of the present disclosure will be more apparent from the following description taken in conjunction with the accompanying drawings, in which:

FIGS. 1A and 1B illustrate an intuitive gesture for creating a new window on a touch screen device according to an embodiment of the present disclosure;

FIG. 2 is a flowchart of a method for using an intuitive gesture for creating a new window on a touch screen device according to an embodiment of the present disclosure;

FIG. 3 illustrates an intuitive gesture for creating a third window on a touch screen device according to an embodiment of the present disclosure;

FIG. 4 is a flowchart of a method for creating a third window on a touch screen device according to an embodiment of the present disclosure;

FIGS. 5A and 5B illustrate an intuitive gesture for maximizing a window on a touch screen device according to an embodiment of the present disclosure.

FIGS. 6A and 6B illustrate an intuitive gesture for restoring a window on a touch screen device according to an embodiment of the present disclosure.

FIG. 7 is a flowchart of a method for maximizing and restoring a window on a touch screen device according to an embodiment of the present disclosure.

FIGS. 8A and 8B illustrate an intuitive gesture for swapping window positions on a touch screen device according to an embodiment of the present disclosure;

FIG. 9 is a flowchart of a method for swapping window positions on a touch screen device according to an embodiment of the present disclosure;

FIGS. 10A and 10B illustrate an intuitive gesture for closing a window on a touch screen device according to an embodiment of the present disclosure;

FIG. 11 is a flowchart of a method for closing a window on a touch screen device according to an embodiment of the present disclosure;

FIG. 12 is a block diagram of a touch screen device according to an embodiment of the present disclosure; and

FIG. 13 is a block diagram of software modules in a storage unit of the touch screen device according to an embodiment of the present disclosure.

Throughout the drawings, like reference numerals will be understood to refer to like parts, components, and structures.

### DETAILED DESCRIPTION

The following description with reference to the accompanying drawings is provided to assist in a comprehensive understanding of various embodiments of the present disclosure as defined by the claims and their equivalents. It includes various specific details to assist in that understanding but these are to be regarded as merely exemplary. Accordingly, those of ordinary skill in the art will recognize that various changes and modifications of the various embodiments described herein can be made without departing from the scope and spirit of the present disclosure. In addition, descriptions of well-known functions and constructions may be omitted for clarity and conciseness.

The terms and words used in the following description and claims are not limited to the bibliographical meanings, but, are merely used by the inventor to enable a clear and consistent understanding of the present disclosure. Accordingly, it should be apparent to those skilled in the art that the following description of various embodiments of the present disclosure is provided for illustration purpose only and not for the purpose of limiting the present disclosure as defined by the appended claims and their equivalents.

It is to be understood that the singular forms “a,” “an,” and “the” include plural referents unless the context clearly dictates otherwise. Thus, for example, reference to “a component surface” includes reference to one or more of such surfaces.

By the term “substantially” it is meant that the recited characteristic, parameter, or value need not be achieved exactly, but that deviations or variations, including for example, tolerances, measurement error, measurement accuracy limitations and other factors known to those of skill in the art, may occur in amounts that do not preclude the effect the characteristic was intended to provide.

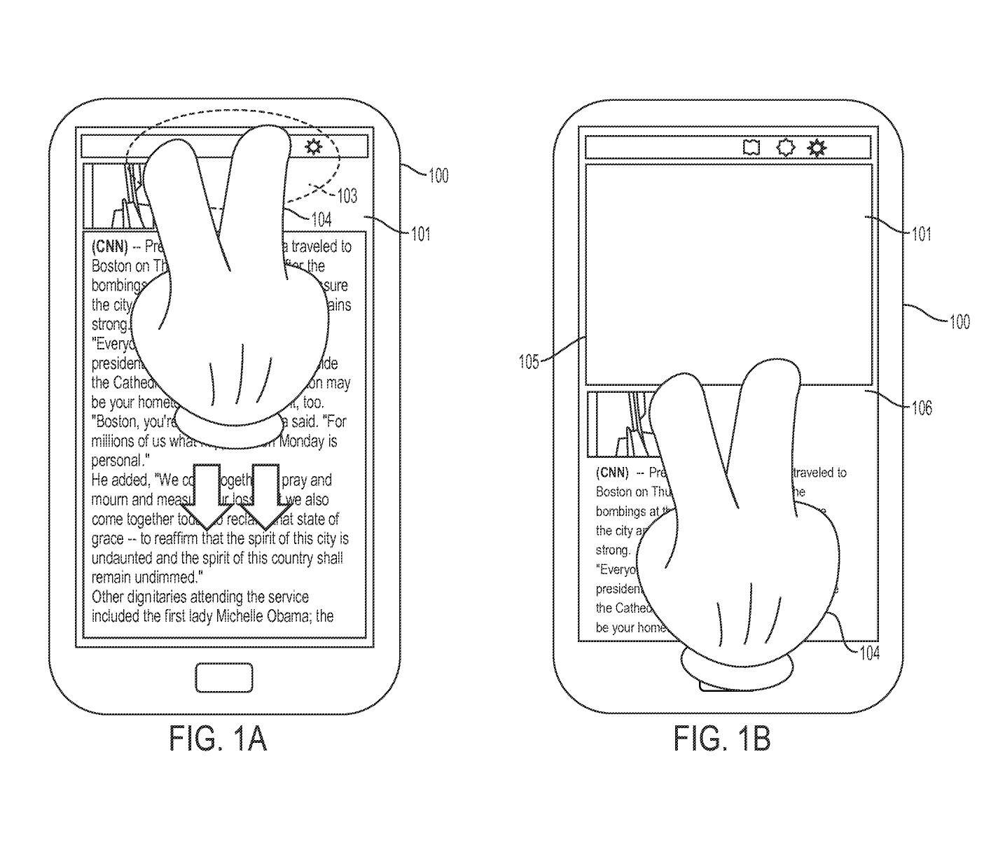

FIGS. 1 through 10, discussed below, and the various embodiments used to describe the principles of the present disclosure in this patent document are by way of illustration only and should not be construed in any way that would limit the scope of the disclosure. Those skilled in the art will understand that the principles of the present disclosure may be implemented in any suitably arranged communications system. The terms used to describe various embodiments are exemplary. It should be understood that these are provided to merely aid the understanding of the description, and that their use and definitions in no way limit the scope of the present disclosure. Terms first, second, and the like are used to differentiate between objects having the same terminology and are in no way intended to represent a chronological order, unless where explicitly stated otherwise. A set is defined as a non-empty set including at least one element.

Terms such as “touch screen device,” “electronic device,” “mobile device,” “handheld device,” “tablet,” “desktop,” “personal computer,” or the like, do not in any way preclude other embodiments from being considered equally applicable. Unless otherwise noted herein, a touch screen device, an electronic device, a mobile device, a handheld device, a tablet, a desktop, a personal computer, or the like, or any other device with a touch screen display, or the like, may, in various implementations be considered interchangeable.

Reference to the terms and concepts of a “window,” a “screen” and a “display” herein should not be considered to limit the embodiments of the present disclosure in any way. In various embodiments, such terms and concepts may be used interchangeably.

In embodiments, reference to controlling one or more windows of a multiple window environment on a touch sensitive device may include creating a new window or dividing a current window into multiple windows. Likewise, controlling one or more windows of a multiple window environment may include repositioning a window or repositioning multiple windows thereof, and may also include resizing one or more windows thereof. In an embodiment, the resizing of one window may affect or cause the resizing of another window. The controlling of one or more windows of the multiple window environment may further include a closing or removal of a window.

FIGS. 1A and 1B illustrate an intuitive gesture for creating a new window on a touch screen device according to an embodiment of the present disclosure.

Referring to FIG. 1A, a mobile device 100 is shown including a touch screen display 101. A multi-point touch event 103 is depicted as being initiated by two fingers of a user's hand 104 at the edge of the touch screen display 101. Upon contact of the multi-point touch event 103, a divider (not shown) is generated by the mobile device at the point of contact of the multi-point touch event 103 at the edge of the touch screen display 101. The divider bisects the touch screen display in at least one direction (see FIG. 1B).

In an embodiment, the multi-point touch event is an event in which contact is made with the touch screen display at two or more points simultaneously. The locations of the points of contact of the multi-point touch event are not limited herein, and may include multiple points of contact which are adjacent to one another, near one another or distant from one another. The points of contact may be made by a same or similar object, e.g., fingers, or may be made by different objects, e.g., a finger and a stylus. Likewise, the size of the area of the points of contact on the touch screen display, as well as the amount of pressure applied at the points of contact of the multi-point touch event may be the same or different. For example, the points of contact of the multi-point touch event may have a defined relationship relative to one another that is based on a distance, a pressure, a type of object applied, or the like. Likewise, there may be no defined relationship between the points of contact of the multi-point touch event.

In embodiments described herein, the edge of the touch screen display may be a perimeter portion thereof which lies nearest to the point at which the touch screen display and a casing of the touch screen device within which the touch screen is embedded abut one another. For example, the edge of the touch screen display may be the edge of a display which abuts the casing of the particular touch screen device in which the display is implemented. Likewise, the edge of the touch screen display may be considered to include a portion of the touch screen display adjacent to the edge thereof, thereby creating a larger edge area which can be more easily touched and manipulated by a user. For example, an edge of the touch screen display may, in embodiments, include an area near the edge that is defined by a distance from the edge of the touch screen display, by a percentage of the touch screen display, by a number of pixels from an edge of the touch screen display, or the like. The edge of the touch screen display may be irregular, and thus may, e.g., take the form a concave or convex shape.

Referring to FIG. 1B, the mobile device 100 is shown including a touch screen display 101, further indicating a result of a swipe motion in which a user's hand 104 has been swiped beginning from the original point of contact of the multi-point touch event 103 (shown in FIG. 1A), i.e., the edge of the touch screen display where a divider 105 was generated, to a new point on the touch screen display denoted by the location 106 of the divider 105, thereby creating a new window. The position of the divider may be set to a new position when a release of the swipe motion or of the multi-point touch event is detected.

In an embodiment, the divider may repositioned (e.g., moved) from the original point of contact of the multi-point touch event to a new point on the touch screen display and may be displayed to the user in real time as the swipe motion occurs. Alternatively, the divider may not be displayed during the swipe motion and may instead be displayed only when a release of the swipe motion is detected, thereby setting a location of the repositioned divider.

In an embodiment, as the divider is moved, a new window may be displayed with the same background information as the original window, which may be a default setting, or it can show the available applications that can be launched later on the new window. Alternatively, the new window may be displayed as a solid color, as a blank window, or the like, or may be displayed based on a user setting. The background of the new window may be displayed during the swipe motion, or may not be displayed until the position of the divider has been set by a release of the swipe motion and the parameters of the new window have been determined.

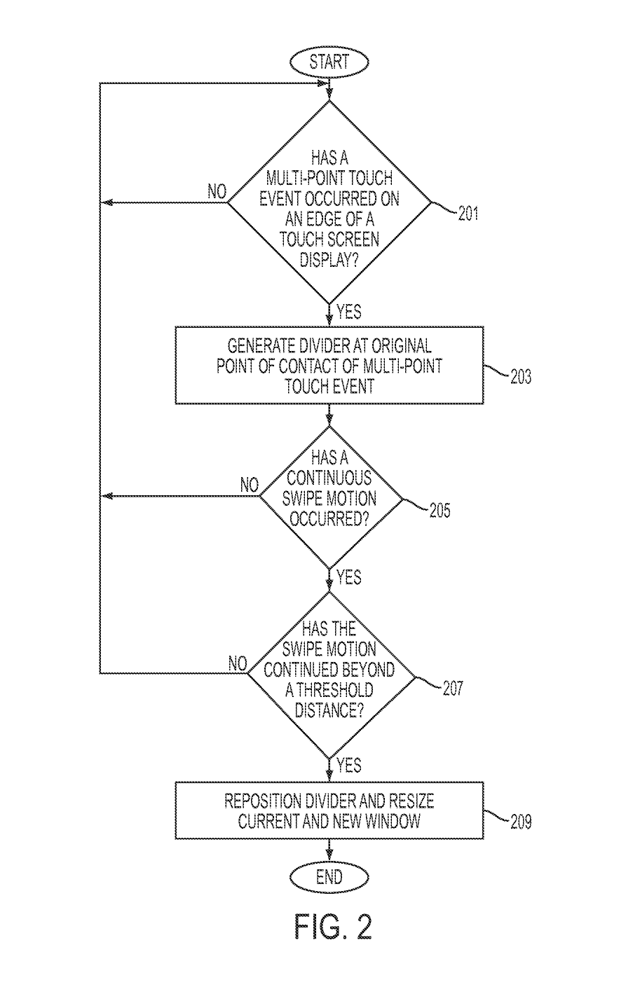

FIG. 2 is a flowchart of a method for using an intuitive gesture for creating a new window on a touch screen device according to an embodiment of the present disclosure.

Referring to FIG. 2, in operation 201, the touch screen device determines whether a multi-point touch event has occurred on an edge of a touch screen display of a touch screen device. In operation 203, if a user has performed a multi-point touch event on an edge of the touch screen display of the touch screen device, the controller generates a divider at an original point of contact of the multi-point touch event. In operation 205, the device determines whether a continuous swipe motion beginning from the original point of contact of the multi-point touch event has occurred. At operation 207, the device determines if the swipe motion has continued toward a new point on the touch screen display that is beyond a threshold distance from the original point of contact of the multi-point touch event. In operation 209, if it is determined that such a continuous swipe motion has occurred; the touch screen device repositions the divider in response to the continuous swipe motion, thereby creating a new window and resizing the current window and the new window.

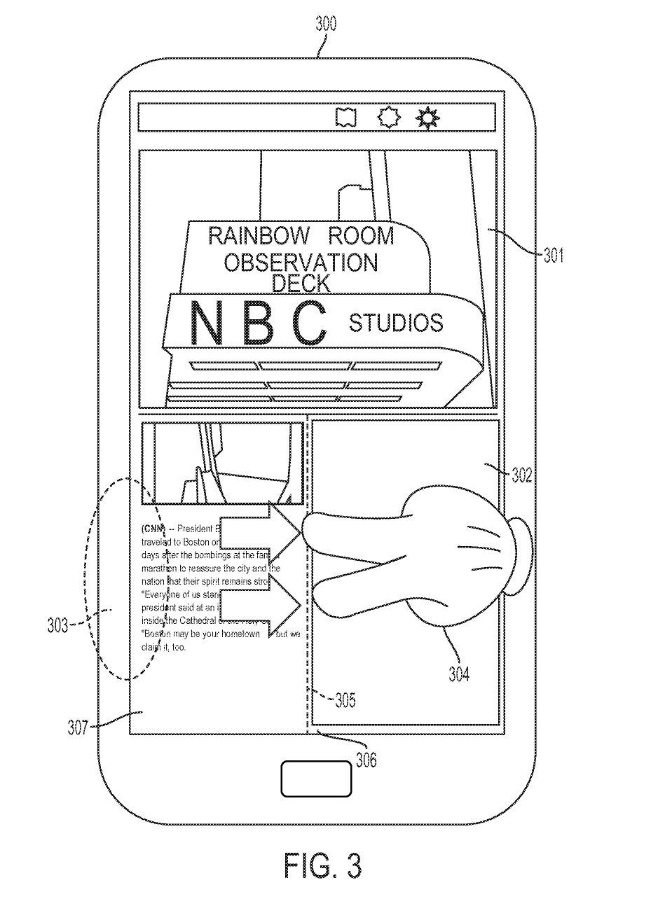

FIG. 3 illustrates an intuitive gesture for creating a third window on a touch window device according to an embodiment of the present disclosure.

Referring to FIG. 3, a mobile device 300 is shown including a touch screen display 301. A swipe motion is depicted as having occurred from a position of a multi-point touch event 303 at the edge of a current window 302, the multi-point touch event 303 having been initiated by two fingers of a user's hand 304 at the edge of the current window 302. The multi-point touch event 303 generated the divider 305 at the point of contact of multi-point the touch event 303 at the edge of the window. The divider is shown as having been moved to a new position 306 and bisects a current window 302, thereby creating a new window 307.

In an embodiment, the divider may be repositioned (e.g., moved) from the original point of contact of the multi-point touch event 303 to the new point on the window and may be displayed to the user in real time as the swipe motion occurs. Alternatively, the divider may not be displayed during the swipe motion and may instead be displayed only when a release of the swipe motion is detected, thereby setting a location of the repositioned divider.

In an embodiment, an edge of the current window may be an edge of a window corresponding to an edge of the entire display of the touch screen device, or may be some smaller portion thereof. Likewise, an edge of a current window may be a divider between two windows, or may be one edge of one of multiple windows displayed on the display of the mobile device.

In an embodiment, the new window created may be displayed with the same background information as the original window, or it can show the available applications that can be launched later on the new window. Alternatively, the new window may be displayed as a solid color, as a blank window, or the like, or may be displayed based on a user setting. The background of the new window may be displayed during the swipe motion, or may not be displayed until the position of the divider has been set by a release of the swipe motion and the parameters of the new window have been determined.

Windows displayed on the touch screen display of the touch screen device may be resized. In an embodiment, a window may be resized by a repositioning of a divider. For example, the touch screen display may be capable of detecting a multi-point tapping touch event on a divider and detecting a continuous swipe motion beginning from the divider on which the multi-point tapping touch event has occurred to a new point on the touch screen display. That is, a multi-point tapping touch event may initiate a state of a divider such that the divider is set to be repositioned. When the continuous swipe motion beginning from the divider on which the multi-point tapping touch event occurs, the divider may be repositioned (e.g., moved) from the original point of contact of the touch event to a new point on the touch screen display, and may be displayed to the user in real time as the swipe motion occurs. Alternatively, the divider may not be displayed during the swipe motion and may instead be displayed only when a release of the swipe motion is detected. In each case, the setting of a new location of the repositioned divider results in a corresponding resizing of the window. A definition of a divider of a window is not limited herein, and may take any form, such as a line, an area, a bar, a design element, or the like, and may include any element within an area of a threshold distance or value from a point thereof.

In an embodiment, the multi-point tapping touch event may include a touch event, as described herein (e.g., an event in which contact is made with the touch screen display at two or more points simultaneously), and may be initiated by a simultaneous tapping of the touch screen display at the two or more points of contact.

In an embodiment, the multi-point tapping touch event may be made by a same or similar object, e.g., fingers, or may be made by different objects, e.g., a finger and a stylus. The locations of the points of contact of the multi-point tapping touch event are not limited herein, and may include multiple points of contact which are adjacent to one another, near one another or distant from one another. In embodiments, the multi-point tapping touch event may include rapid tapping or slow tapping, and may include tapping in a pattern. The size of the area of the points of contact of the multi-point tapping touch event on the touch screen display, as well as the pressure applied at the points of contact of the multi-point tapping touch event may be the same or different. For example, the points of contact of the multi-point tapping touch event may have a defined relationship relative to one another that is based on a distance, a pressure, a type of object applied, or the like. Likewise, there may be no defined relationship between the points of contact of the multi-point tapping touch event.

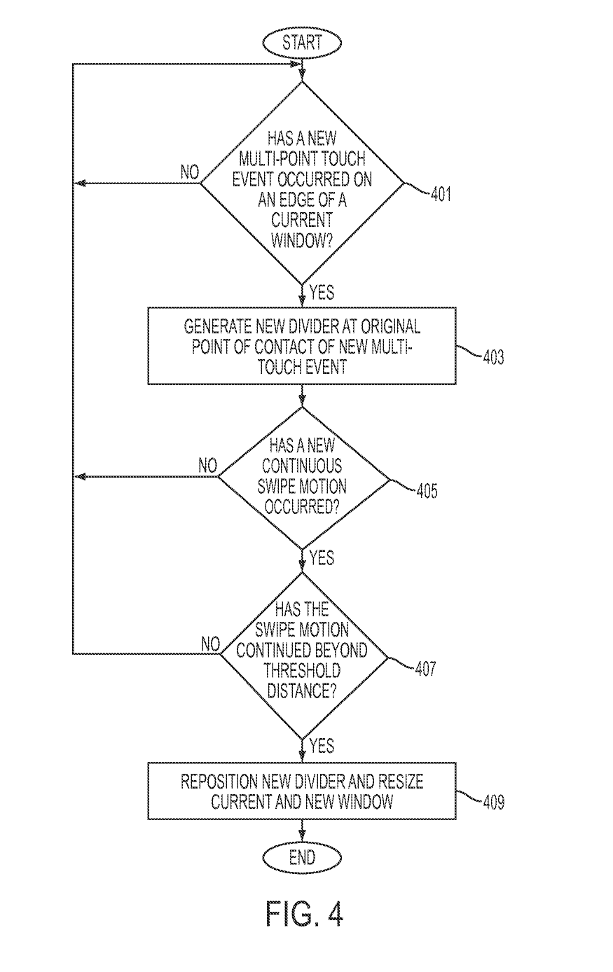

FIG. 4 is a flowchart of a method for creating a third window on a touch screen device according to an embodiment of the present disclosure.

Referring to FIG. 4, it will be assumed that a user is already operating in a multiple window environment. At operation 401, the touch screen device determines whether a new multi-point touch event including the simultaneous contact at two or more points has occurred on an edge of a current window of the display. If it is determined that such an event has occurred, at operation 403, the device generates, at an original point of contact of the new multi-point touch event on the edge of the current window, a new divider bisecting the current window in response to the multi-point touch event. At operation 405, the touch screen device determines whether a new continuous swipe motion beginning from a position of the new divider of the current window has occurred. At operation 407, the touch screen device determines if the swipe motion has proceeded to a point on the current window that is beyond a threshold distance from the original position of the new divider. If such a swipe has occurred, the touch screen device repositions the new divider in response to the new continuous swipe motion at operation 409, thereby creating a new window and resizing the current window and the new window. In an embodiment, the new window created may be a third, fourth, fifth, or any further window of the display.

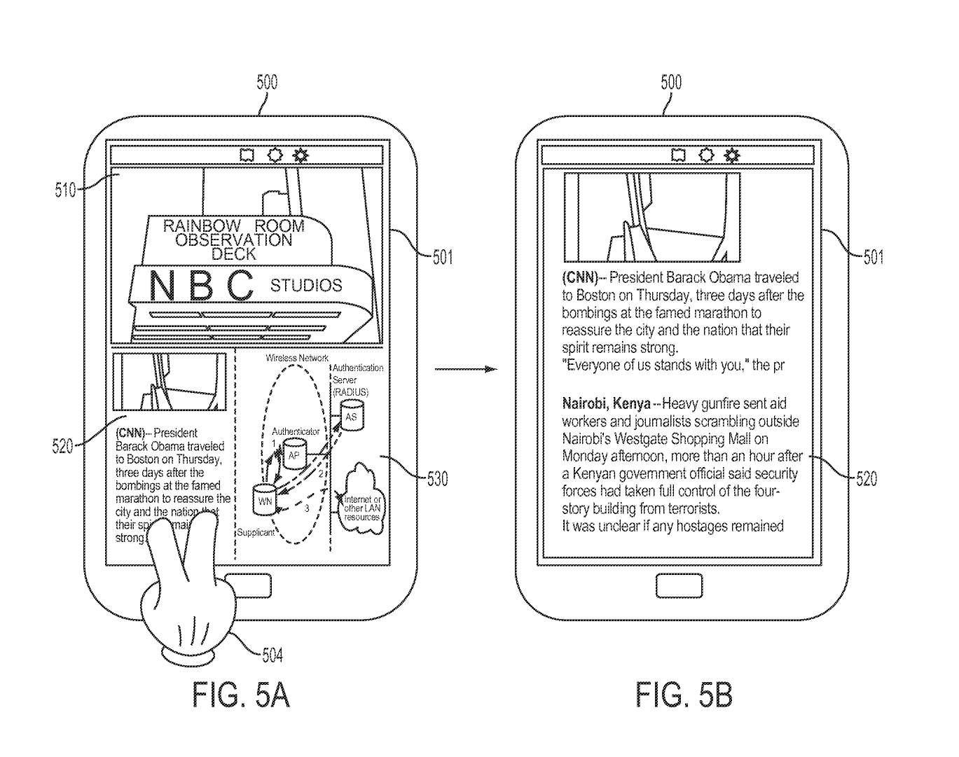

FIGS. 5A and 5B illustrate an intuitive gesture for maximizing a window on a touch screen device according to an embodiment of the present disclosure.

Referring to FIG. 5A, a mobile device 500 is shown including a touch screen 501 displaying three windows 510, 520 and 530. In FIG. 5A, a multi-point tapping touch event is initiated in an area of a window 520, the multi-point tapping touch event including double tapping two or more fingers of a user's hand 504 in an area of the window 520. The multi-point double tapping touch event results in a maximization of the window 520 as is shown in FIG. 5B. The multi-point double tapping touch event may include two consecutive multi-finger tapping events that occur within a particular time threshold.

Referring to FIG. 5B, the maximized window 520 is shown as occupying the entire area of touch screen display 501. In embodiments, however, the maximized window 520 may occupy less than the total area of the touch screen display 501.

In an embodiment, the multi-point double tapping touch event for maximizing a window or restoring a window includes a double tapping gesture, or the like, and may further include the same type of a touch event as that described herein with respect to other embodiments. For example, a multi-point double tapping touch event may include a touch event in which contact is made with the touch screen display at two or more points simultaneously, and which is initiated by a simultaneous tapping of the touch screen display at the two or more points of contact.

In an embodiment, the multi-point tapping touch event may be made by a same or similar object, e.g., fingers, or may be made by different objects, e.g., a finger and a stylus. The locations of the points of contact of the multi-point tapping touch event are not limited herein, and may include multiple points of contact which are adjacent to one another, near one another or distant from one another. In embodiments, the multi-point tapping touch event may include rapid tapping or slow tapping, and may include tapping in a pattern. A definition of an area of a window is not limited herein, and may be defined as being within a threshold distance or value from another area of a window. Alternatively, an area may be defined as being a threshold distance or value away from an edge of a window, or the like. The size of the area of the points of contact of the multi-point tapping touch event on the touch screen display, as well as the pressure applied at the points of contact of the multi-point tapping touch event may be the same or different. For example, the points of contact of the multi-point tapping touch event may have a defined relationship relative to one another that is based on a distance, a pressure, a type of object applied, or the like. Likewise, there may be no defined relationship between the points of contact of the multi-point tapping touch event.

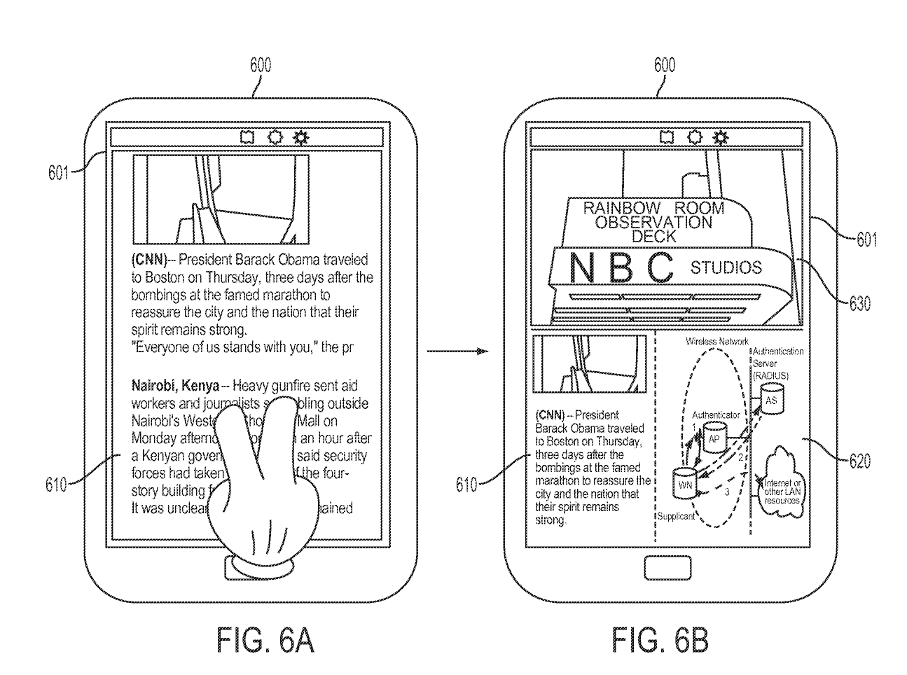

FIGS. 6A and 6B illustrate an intuitive gesture for restoring a window on a touch screen device according to an embodiment of the present disclosure.

Referring to FIG. 6A, a mobile device 600 is shown including a touch screen display 601 displaying a maximized window 610. In FIG. 6A, a multi-point tapping touch event is initiated by double tapping two or more fingers of a user's hand 604 in an area of the window 610. The multi-point double tapping touch event results in a restoration of the maximized window 610 from a maximized state or size to a lesser state or to a non-maximized state or size, as depicted in FIG. 6B.

Referring to FIG. 6B, the restored window 610 is shown after the restoration multi-point double tapping touch event in a non-maximized state. A total of three windows, i.e., 610, 620 and 630, are shown, each window in a non-maximized state and occupying only a portion of window 601.

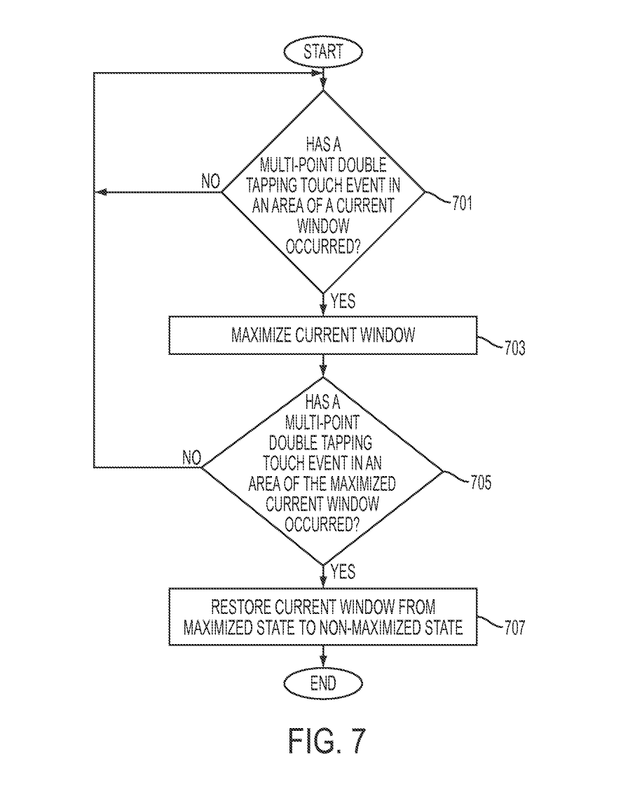

FIG. 7 is a flowchart of a method for maximizing and restoring a window on a touch screen device according to an embodiment of the present disclosure.

Referring to FIG. 7, it will be assumed that a user is already operating in a multiple window environment. At operation 701, the touch screen device determines whether a multi-point double tapping touch event in an area of a current window has occurred. If such a multi-point double tapping touch event has occurred, the touch screen device maximizes the current window at operation 703. At operation 705, the touch screen device determines whether a multi-point double tapping touch event has occurred in an area of the maximized current window. If such a multi-point tapping touch event has occurred, the touch screen device restores the maximized current window from its maximized state to a lesser state or to a non-maximized state at operation 707.

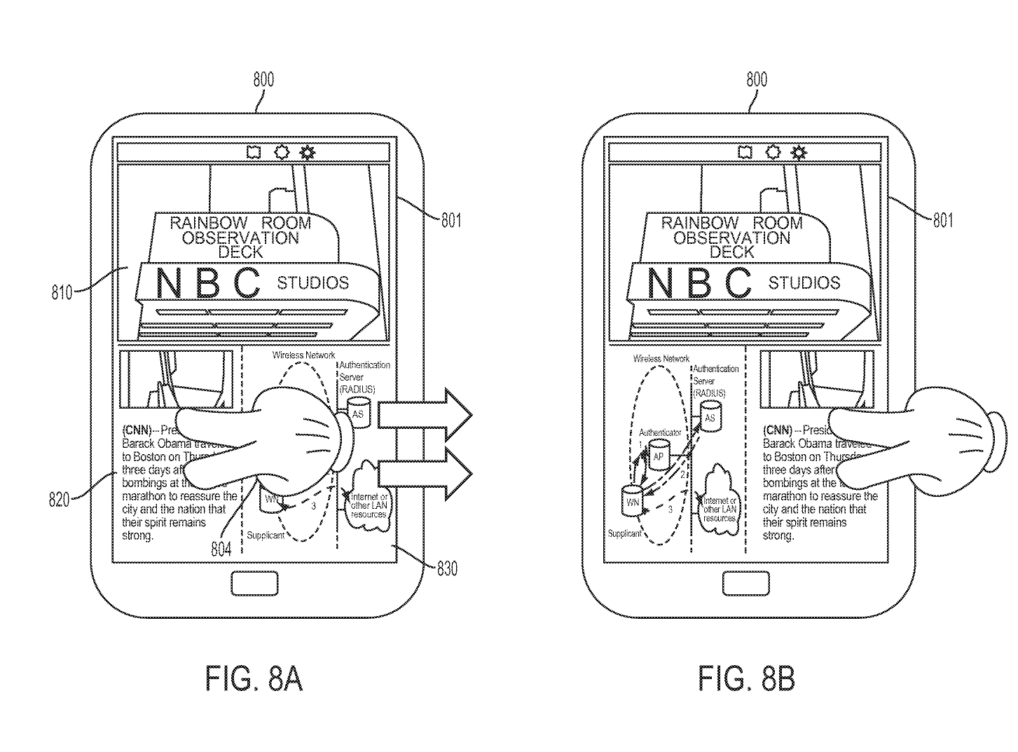

FIGS. 8A and 8B illustrate an intuitive gesture for swapping window positions on a touch screen device according to an embodiment of the present disclosure.

Referring to FIG. 8A, a mobile device 800 is shown including a touch screen display 801 displaying three windows 810, 820 and 830. In FIG. 8A, a multi-point tapping touch event (not shown) has been initiated in a central area of window 820, the multi-point tapping touch event having been initiated by tapping two fingers of a user's hand 504 in the central area of window 820. A continuous swipe motion is depicted which begins from the central area of window 820 and proceeds to a central area of a window 830.

Referring to FIG. 8B, once the release of the swipe motion beginning in the central area of window 820 has progressed to the central area of the window 830, a swap is completed, i.e., window 820 is repositioned to take the place of window 830, and window 830 is repositioned to take the place of the window 820.

In an embodiment, the multi-point tapping touch event preceding a window swap may be the same type of a multi-point tapping touch event as that described herein with respect to other embodiments. For example, a multi-point tapping touch event may include a multi-point touch event in which contact is made with the touch screen display at two or more points simultaneously, and which is initiated by a simultaneous tapping of the touch screen display at the two or more points of contact.

In an embodiment, the multi-point tapping touch event may be made by a same or similar object, e.g., fingers, or may be made by different objects, e.g., a finger and a stylus. The locations of the points of contact of the multi-point tapping touch event are not limited herein, and may include multiple points of contact which are adjacent to one another, near one another or distant from one another. In embodiments, the multi-point tapping touch event may include rapid tapping or slow tapping, and may include tapping in a pattern. A definition of central area of a window is not limited herein, and may be defined as being within a threshold distance or value from a center point of an area of a window. Alternatively, a central area may be defined as being a threshold distance or value away from an edge of a window, or the like. The size of the area of the points of contact of the multi-point tapping touch event on the touch screen display, as well as the pressure applied at the points of contact of the multi-point tapping touch event may be the same or different. For example, the points of contact of the multi-point tapping touch event may have a defined relationship relative to one another that is based on a distance, a pressure, a type of object applied, or the like. Likewise, there may be no defined relationship between the points of contact of the multi-point tapping touch event.

In an embodiment, when two windows are swapped, each window may acquire the size and dimension of the window for which it is swapped. In other embodiments, each window may maintain its original size and dimension and simply change place with the window with which it is swapped. In yet further embodiments, the size and dimensions of the windows may change from their original size, and may not acquire the size and dimension of the window for which they are swapped.

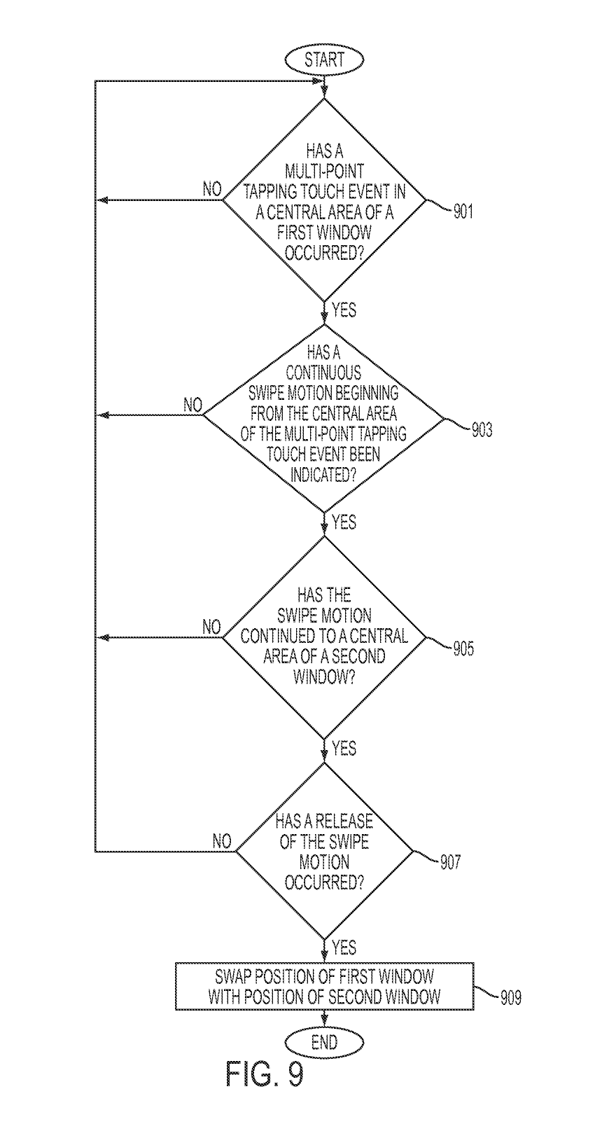

FIG. 9 is a flowchart of a method for swapping window positions on a touch screen device according to an embodiment of the present disclosure.

Referring to FIG. 9, it will be assumed that a user is already operating in a multiple window environment. At operation 901, the touch screen device determines whether a multi-point tapping touch event in a central area of a first window has occurred. If such a tapping event has occurred, the touch screen device determines, at operation 903, whether a continuous swipe motion beginning from the central area of the multi-point tapping touch event of the first window has been initiated. If such a swipe motion has been initiated, the touch screen device determines whether the swipe motion has continued to a central area of a second window has occurred at operation 905. If a swipe motion has continued to a central area of a second window, the touch screen device determines if a release of the swipe motion in the central area of the second window has occurred at operation 907. If such a release event has occurred, then, at operation 909, the touch screen device repositions the first window to the place of the second window and repositions the second window to the place of the first window (i.e., a “swap”) in response to the release of the continuous drag motion.

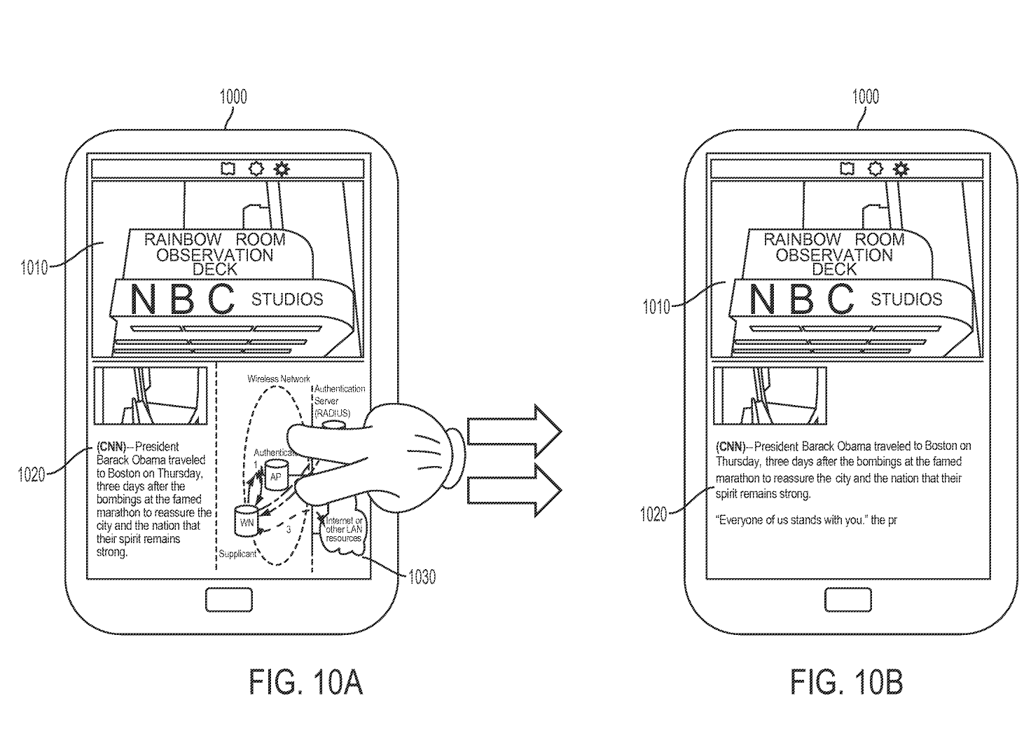

FIGS. 10A and 10B illustrate an intuitive gesture for closing a window on a touch screen device according to an embodiment of the present disclosure.

Referring to FIG. 1 OA, a mobile device 1000 is shown including a touch screen display 701 displaying three windows 1010, 1020 and 1030. In FIG. 10A, a multi-point tapping touch event as described herein (not shown) has been initiated in a central area of window 1030. The multi-point tapping touch event has initiated a state of window 1030 such that window 1030 is set to be closed (i.e., removed). A continuous swipe motion is depicted which begins from the central area of window 1030 and proceeds to an edge of the window (of the display) in order to delete the window.

Referring to FIG. 10B, window 1030 depicts the display of the touch screen device after window 1030 has been closed. That is, window 1030 has been closed by the multi-point tapping touch event and the swiping motion, and window 1020 has been resized to occupy the space formerly occupied by window 1030.

In an embodiment, as the continuous swipe motion beginning from the central area of the window on which the multi-point tapping touch event has occurred progresses toward an edge of the window, the window and a divider may be continually repositioned (e.g., moved) from an original position so as to resemble being removed from, or to appear to be “falling off” of, the display in real time. Alternatively, the divider and the window may not be displayed as changing position during the swipe motion, and may instead be displayed in a final position (or may not displayed in the case of elimination or removal) only when a release of the swipe motion is detected, thereby setting a new, expanded location of, and corresponding resizing of, another window on the display of the touch screen device.

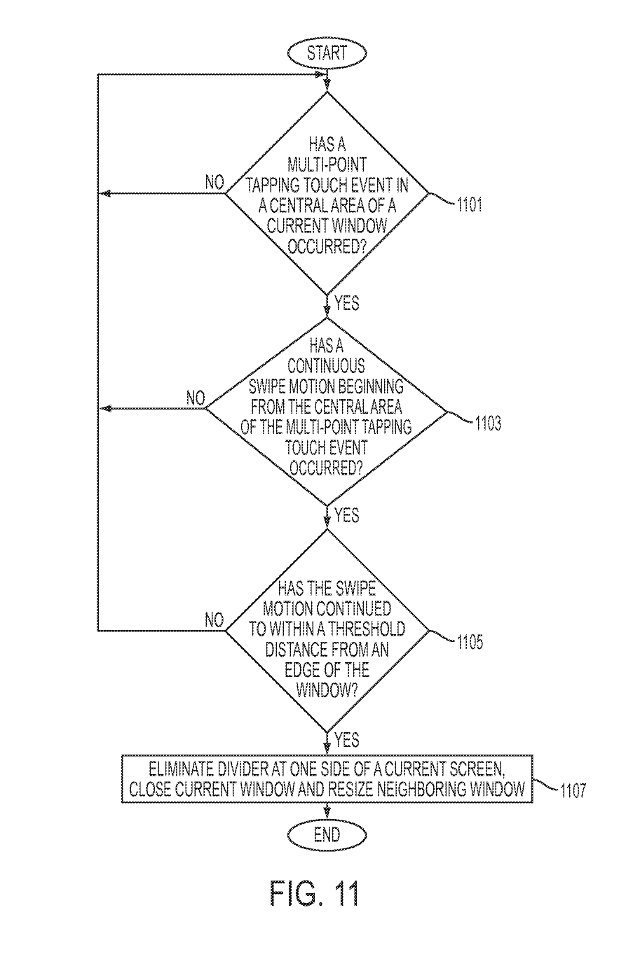

FIG. 11 is a flowchart of a method for closing a window on a touch screen device according to an embodiment of the present disclosure.

Referring to FIG. 11, it will be assumed that a user is already operating in a multiple window environment. At operation 1101, the touch screen device determines whether a multi-point tapping touch event in a central area of a current window has occurred. If such a multi-point tapping touch event has occurred, the touch screen device determines, at operation 1103, whether a continuous swipe motion beginning from the central area of the multi-point tapping touch event of the current window has occurred. If such a swipe motion has occurred, the touch screen device determines, at operation 1105, whether the swipe motion has continued to within a threshold distance from the edge of the current window. At operation 1107, if the touch screen device determines that the swipe motion has continued to within a threshold distance from the edge of the current window, the touch screen device eliminates a divider at one edge of the current window, thereby closing a current window of the display and resizing a neighboring window.

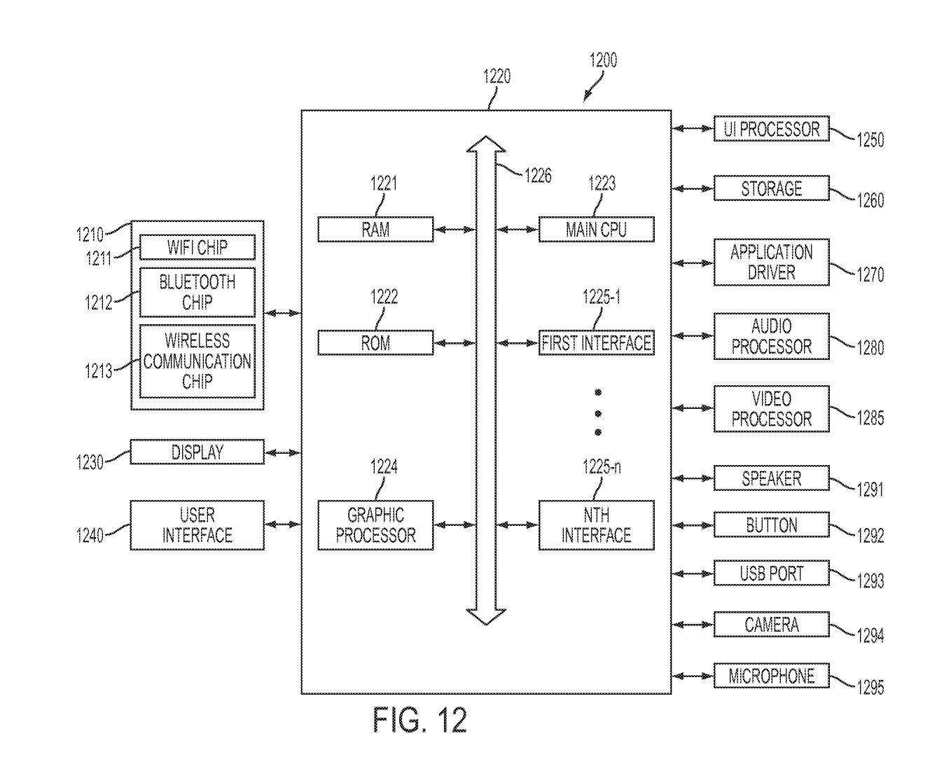

FIG. 12 is a block diagram of a touch screen device according to an embodiment of the present disclosure.

Referring to FIG. 12, the touch screen device 1200 includes a communication device 1210, the controller 1220, the display 1230, a user interface 1240, a storage unit 1260, an application driver 1270, an audio processor 1280, a video processor 1285, a speaker 1291, a button 1292, a USB port 1293, a camera 1294, and a microphone 1295.

The touch screen device 1210 herein is not limited, and may perform communication functions with various types of external apparatuses. The communication device 1210 may include various communication chips such as a Wireless Fidelity (WiFi) device 1211, a Bluetooth® device 1212, a wireless communication device 1213, and so forth. The WiFi chip 1211 and the Bluetooth chip 1212 perform communication according to a WiFi standard and a Bluetooth® standard, respectively. The wireless communication 1213 chip performs communication according to various communication standards such as Zigbee®, 3rd Generation (3G), 3rd Generation Partnership Project (3GPP), Long Term Evolution (LTE), and so forth. In addition, the touch screen device 1210 may further include a Near Field Communication (NFC) chip that operates according to an NFC method by using bandwidth from various RF-ID frequency bands such as 135 kHz, 13.56 MHz, 433 MHz, 860-960 MHz, 2.45 GHz, and so on.

In operation, the controller 1220 may read a computer readable medium and performs instructions according to the computer readable medium, which is stored in the storage unit 1260. The storage unit 1260 may also store various data such as Operating System (O/S) software, applications, multimedia content (e.g., video files, music files, etc.), user data (documents, settings, etc.), and so forth.

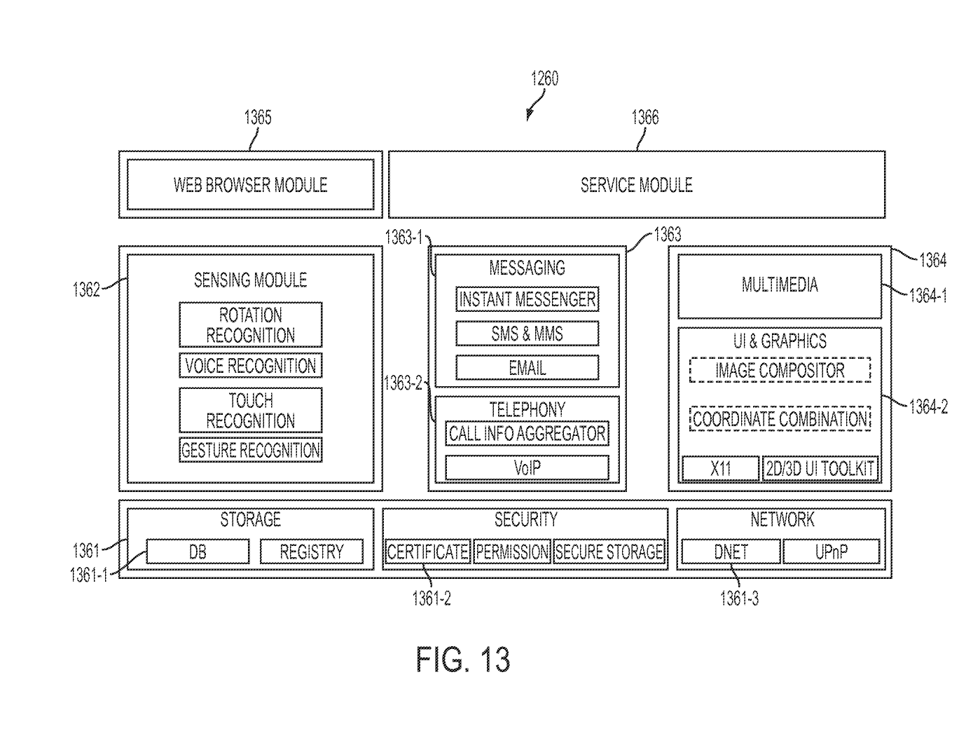

Other software modules which are stored in the storage unit 960 will be described later with reference to FIG. 13.

The user interface 1240 is an input device configured to receive user input and transmit a user command corresponding to the user input to the controller 1220. For example, the user interface 1240 may be implemented by any suitable input such as touch pad, a key pad including various function keys, number keys, special keys, text keys, or a touch screen display, for example. Accordingly, the user interface 1240 receives various user commands and intuitive gestures to create, reposition, resize and close multiple windows on the display of the touch sensitive device. For example, the user interface 1240 may receive a user command or an intuitive gesture to reposition a divider or create or remove a window.

The UI processor 1250 may generate various types of Graphical UIs (GUIs).

In addition, the UI processor 1250 may process and generate various UI windows in 2D or 3D form. Herein, the UI window may be a screen which is associated with the execution of the integrated multiple window application as described above. In addition, the UI window may be a window which displays text or diagrams such as a menu screen, a warning sentence, a time, a channel number, etc.

Further, the UI processor 1250 may perform operations such as 2D/3D conversion of UI elements, adjustment of transparency, color, size, shape, and location, highlights, animation effects, and so on.

For example, the UI processor 1250 may process icons displayed on the window in various ways as described above.

The storage unit 1260 is a storage medium that stores various computer readable mediums that are configured to operate the touch screen device 1200, and may be realized as any suitable storage device such as a Hard Disk Drive (HDD), a flash memory module, and so forth. For example, the storage unit 1260 may comprise a Read Only Memory (ROM) for storing programs to perform operations of the controller 1220, a Random Access Memory (RAM) 921 for temporarily storing data of the controller 1220, and so forth. In addition, the storage unit 1260 may further comprise Electrically Erasable and Programmable ROM (EEPROM) for storing various reference data.

The application driver 1270 executes applications that may be provided by the touch screen device 1200. Such applications are executable and perform user desired functions such as playback of multimedia content, messaging functions, communication functions, display of data retrieved from a network, and so forth.

The audio processor 1280 is configured to process audio data for input and output of the touch screen device 1200. For example, the audio processor 1280 may decode data for playback, filter audio data for playback, encode data for transmission, and so forth.

The video processor 1285 is configured to process video data for input and output of the touch screen device 1200. For example, the video processor 985 may decode video data for playback, scale video data for presentation, filter noise, convert frame rates and/or resolution, encode video data input, and so forth.

The speaker 1291 is provided to output audio data processed by the audio processor 980 such as alarm sounds, voice messages, audio content from multimedia, audio content from digital files, and audio provided from applications, and so forth.

The button 1292 may be configured based on the touch screen device 900 and include any suitable input mechanism such as a mechanical button, a touch pad, a wheel, and so forth. The button 1292 is generally on a particular position of the touch screen device 1200, such as on the front, side, or rear of the external surface of the main body. For example, a button to turn the touch screen device 900 on and off may be provided on an edge.

The USB port 1293 may perform communication with various external apparatuses through a USB cable or perform recharging. In other examples, suitable ports may be included to connect to external devices such as a 802.11 Ethernet port, a proprietary connector, or any suitable connector associated with a standard to exchange information.

The camera 1294 may be configured to capture (i.e., photograph) an image as a photograph or as a video file (i.e., movie). The camera 1294 may include any suitable number of cameras in any suitable location. For example, the touch screen device 1294 may include a front camera and rear camera.

The microphone 1295 receives a user voice or other sounds and converts the same to audio data. The controller 1220 may use a user voice input through the microphone 1295 during an audio or a video call, or may convert the user voice into audio data and store the same in the storage unit 1260.

When the camera 1294 and the microphone 1295 are provided, the controller 1220 may receive based on a speech input into the microphone 1295 or a user motion recognized by the camera 1294. Accordingly, the touch screen device 1200 may operate in a motion control mode or a voice control mode. When the touch screen device 1200 operates in the motion control mode, the controller 1220 captures images of a user by activating the camera 1294, determines if a particular user motion is input, and performs an operation according to the input user motion. When the touch screen device 1200 operates in the voice control mode, the controller 1220 analyzes the audio input through the microphone and performs a control operation according to the analyzed audio.

In addition, various external input ports provided to connect to various external terminals such as a headset, a mouse, a Local Area Network (LAN), etc., may be further included.

Generally, the controller 1220 controls overall operations of the touch screen device 1200 using computer readable mediums that are stored in the storage unit 960.

For example, the controller 1220 may initiate an application stored in the storage unit 1260, and execute the application by displaying a user interface to interact with the application. In other examples, the controller 1220 may play back media content stored in the storage unit 1260 and may communicate with external apparatuses through the communication device 1210.

More specifically, the controller 1220 may comprise the RAM 1221, a ROM 1222, a main CPU 1223, a graphic processor 1224, first to nth interfaces 1225-1-1225-n, and a bus 1226. In some examples, the components of the controller 1220 may be integral in a single packaged integrated circuit. In other examples, the components may be implemented in discrete devices (e.g., the graphic processor 1224 may be a separate device).

The RAM 1221, the ROM 1222, the main CPU 1223, the graphic processor 1224, and the first to nth interfaces 1225-1-1225-n may be connected to each other through the bus 1226.

The first to nth interfaces 1225-1-1225-n are connected to the above-described various components. One of the interfaces may be a network interface which is connected to an external apparatus via the network.

The main CPU 1223 accesses the storage unit 1260 and initiates a booting process to execute the O/S stored in the storage unit 1260. After booting the O/S, the main CPU 1223 is configured to perform operations according to software modules, contents, and data stored in the storage unit 960.

The ROM 1222 stores a set of commands for system booting. If a turn-on command is input and power is supplied, the main CPU 1223 copies an O/S stored in the storage unit 1260 onto the RAM 1221 and boots a system to execute the O/S. Once the booting is completed, the main CPU 1223 may copy application programs in the storage unit 1260 onto the RAM 1221 and execute the application programs.

The graphic processor 1224 is configured to generate a window including objects such as, for example an icon, an image, and text using a computing unit (not shown) and a rendering unit (not shown). The computing unit computes property values such as coordinates, shape, size, and color of each object to be displayed according to the layout of the window using input from the user. The rendering unit generates a window with various layouts including objects based on the property values computed by the computing unit. The window generated by the rendering unit is displayed by the display 1230.

Albeit not illustrated in the drawing, the touch screen device 900 may further comprise a sensor (not shown) configured to sense various manipulations such as touch, rotation, tilt, pressure, approach, etc. with respect to the touch screen device 900. In particular, the sensor (not shown) may include a touch sensor that senses a touch that may be realized as a capacitive or resistive sensor. The capacitive sensor calculates touch coordinates by sensing micro-electricity provided when the user touches the surface of the display 930, which includes a dielectric coated on the surface of the display 930. The resistive sensor comprises two electrode plates that contact each other when a user touches the screen, thereby allowing electric current to flow to calculate the touch coordinates. As such, a touch sensor may be realized in various forms. In addition, the sensor may further include additional sensors such as an orientation sensor to sense a rotation of the touch screen device 1200 and an acceleration sensor to sense displacement of the touch screen device 1200.

Components of the touch screen device 1200 may be added, omitted, or changed according to the configuration of the touch screen device. For example, a Global Positioning System (GPS) receiver (not shown) to receive a GPS signal from GPS satellite and calculate the current location of the user of the touch screen device 1200, and a Digital Multimedia Broadcasting (DMB) receiver (not shown) to receive and process a DMB signal may be further included. In another example, a camera may not be included because the touch screen device 1200 is configured for a high-security location.

FIG. 13 is a block diagram of software modules in a storage unit of the touch screen device according to an embodiment of the present disclosure.

Referring to FIG. 13, the storage unit 1260 may store software including a base module 1361, a sensing module 1362, a communication module 1363, a presentation module 1364, a web browser module 1365, and a service module 1366.

The base module 1361 refers to a basic module which processes a signal transmitted from hardware included in the touch screen device 1200 and transmits the processed signal to an upper layer module. The base module 1061 includes a storage module 1361-1, a security module 1361-2, and a network module 1361-3. The storage module 1361-1 is a program module including a database or a registry. The main CPU 1223 may access a database in the storage unit 1260 using the storage module 1361-1 to read out various data. The security module 1361-2 is a program module which supports certification, permission, secure storage, etc. with respect to hardware, and the network module 1361-3 is a module which supports network connections, and includes a DNET module, a Universal Plug and Play (UPnP) module, and so on.

The sensing module 1362 collects information from various sensors, analyzes the collected information, and manages the collected information. The sensing module 1362 may include suitable modules such as a face recognition module, a voice recognition module, a touch recognition module, a motion recognition (i.e., gesture recognition) module, a rotation recognition module, an NFC recognition module, and so forth.

The communication module 1363 performs communication with other devices. The communication module 1363 may include any suitable module according to the configuration of the touch screen device 1200 such as a messaging module 1363-1 (e.g., a messaging application), a Short Message Service (SMS) and a Multimedia Message Service (MMS) module, an e-mail module, etc., and a call module 1363-2 that includes a call information aggregator program module, a Voice over Internet Protocol (VoIP) module, and so forth.

The presentation module 1364 composes an image to display on the display 1230. The presentation module 1064 includes suitable modules such as a multimedia module 1364-1 and a UI rendering module 1364-2. The multimedia module 1364-1 may include suitable modules for generating and reproducing various multimedia contents, windows, and sounds. For example, the multimedia module 1364-1 includes a player module, a camcorder module, a sound processing module, and so forth. The UI rendering module 1364-2 may include an image compositor module for combining images, a coordinates combination module for combining and generating coordinates on the window where an image is to be displayed, an X11 module for receiving various events from hardware, a 2D/3D UI toolkit for providing a tool for composing a UI in 2D or 3D form, and so forth.

The web browser module 1365 accesses a web server to retrieve data and displays the retrieved data in response to a user input. The web browser module 1365 may also be configured to transmit user input to the web server. The web browser module 1365 may include suitable modules such as a web view module for composing a web page according to the markup language, a download agent module for downloading data, a bookmark module, a web-kit module, and so forth.

The service module 1366 is a module including applications for providing various services. More specifically, the service module 1366 may include program modules such as a navigation program, a content reproduction program, a game program, an electronic book program, a calendar program, an alarm management program, other widgets, and so forth.

It should be noted that the various embodiments of the present disclosure as described above typically involve the processing of input data and the generation of output data to some extent. This input data processing and output data generation may be implemented in hardware or software in combination with hardware. For example, specific electronic components may be employed in a mobile device or similar or related circuitry for implementing the functions associated with the various embodiments of the present disclosure as described above. Alternatively, one or more processors operating in accordance with stored instructions may implement the functions associated with the various embodiments of the present disclosure as described above. If such is the case, it is within the scope of the present disclosure that such instructions may be stored on one or more non-transitory processor readable mediums. Examples of the processor readable mediums include Read-Only Memory (ROM), Random-Access Memory (RAM), CD-ROMs, magnetic tapes, floppy disks, and optical data storage devices. The processor readable mediums can also be distributed over network coupled computer systems so that the instructions are stored and executed in a distributed fashion. Also, functional computer programs, instructions, and instruction segments for accomplishing the present disclosure can be easily construed by programmers skilled in the art to which the present disclosure pertains.

What is claimed is:

1. A method of creating multiple windows on a touch screen display of an electronic device, the method comprising:
detecting a multi-point touch event on an edge of the touch screen display, the multi-point touch event including a simultaneous contact of the touch screen display at two or more points.

2. The method of claim 1, further comprising:
generating, at an original point of contact of the multi-point touch event, a divider bisecting the touch screen display in response to the multi-point touch event.

3. The method of claim 2, further comprising:
detecting a continuous swipe motion beginning from the original point of contact of the multi-point touch event to a new point on the touch screen display that is beyond a threshold distance from the original point of contact of the multi-point touch event;
repositioning the divider in response to the continuous swipe motion, thereby creating a new window; and
displaying the same background information on each window of the multiple windows.

4. The method of claim 3, further comprising:
detecting a new multi-point touch event on an edge of a current window, the new multi-point touch event including the simultaneous contact of the edge of the new window at two or more points;
generating, at an original point of contact of the new multi-point touch event on the edge of the current window, a new divider bisecting the current window in response to the multi-point touch event;
detecting a new continuous swipe motion beginning from a position of the new divider of the current window to a point on the current window that is beyond a threshold distance from the original position of the new divider;
repositioning the new divider in response to the new continuous swipe motion, thereby creating a new window; and
displaying the same background information on each window of the multiple windows.

5. The method of claim 4, wherein the threshold distance is 5% of the total length of the touch screen display measured in the direction of the continuous swipe motion.

6. The method of claim 3, further comprising:
detecting a multi-point tapping touch event on the divider;
detecting a continuous swipe motion beginning from the divider to a new point on the touch screen display; and
repositioning the divider in response to the continuous swipe motion.

7. The method of claim 4, further comprising:
detecting a multi-point tapping touch event in a central area of a first window;
detecting a continuous swipe motion beginning from the central area of the multi-point tapping touch event of the first window to a central area of a second window;
detecting a release of the swipe motion in the central area of the second window; and
repositioning the first window to the place of the second window and repositioning the second window to the place of the first window in response to the release of the continuous drag motion.

8. The method of claim 4, further comprising:
detecting a multi-point tapping touch event in a central area of a current window;
detecting a continuous swipe motion beginning from the central area of the multi-point tapping touch event of the current window;
repositioning the current window so as to appear to be removing the current window from the display in response to the swipe motion;
if the swipe motion continues to within a threshold distance of the edge of another window, eliminating a divider at one edge of the current window; and
eliminating a window of the multiple windows.

9. The method of claim 4, wherein changes to a window occur visibly to a user as a multi-point touch event or a swipe motion occur.

10. At least one non-transitory processor readable medium for storing a computer program of instructions configured to be readable by at least one processor for instructing the at least one processor to execute a computer process for performing the method as recited in claim 1.

11. An electronic device capable of displaying multiple windows on a touch screen display thereof, the electronic device comprising:
a touch screen display capable of displaying multiple windows; and
a controller configured to detect a multi-point touch event on an edge of the touch screen display, the multi-point touch event including the simultaneous contact of the touch screen display at two or more points.

12. The electronic device of claim 11, wherein the controller is further configured to generate, at an original point of contact of the multi-point touch event, a divider bisecting the touch screen display in response to the multi-point touch event.

13. The electronic device of claim 12, wherein the controller is further configured to:
detect a continuous swipe motion beginning from the original point of contact of the multi-point touch event to a new point on the touch screen display that is beyond a threshold distance from the original point of contact of the multi-point touch event;
reposition the divider in response to the continuous swipe motion, thereby creating a new window; and
display the same background information on each window of the multiple windows.

14. The electronic device of claim 13, wherein the controller is further configured to:
detect a new multi-point touch event on an edge of a current window, the new multi-point touch event including the simultaneous contact of an edge of the new window at two or more points;
generate, at an original point of contact of the new multi-point touch event on the edge of the current window, a new divider bisecting the current window in response to the multi-point touch event;
detect a new continuous swipe motion beginning from a position of the new divider of the current window to a point on the current window that is beyond a threshold distance from the original position of the new divider;
reposition the new divider in response to the new continuous swipe motion, thereby creating a new window; and
display the same background information on each window of the multiple windows.

15. The electronic device of claim 14, wherein the threshold distance is 5% of the total length of the touch screen display measured in the direction of the continuous swipe motion.

16. The electronic device of claim 13, wherein the controller is further configured to:
detect a multi-point tapping touch event on the divider;
detect a continuous swipe motion beginning from the divider to a new point on the touch screen display; and
reposition the divider in response to the continuous swipe motion.

17. The electronic device of claim 14, wherein the controller is further configured to:
detect a multi-point tapping touch event in a central area of a first window;
detect a continuous swipe motion beginning from the central area of the multi-point tapping touch event of the first window to a central area of a second window;
detect a release of the swipe motion in the central area of the second window; and
reposition the first window to the place of the second window and reposition the second window to the place of the first window in response to the release of the continuous drag motion.

18. The electronic device of claim 14, wherein the controller is further configured to:
detect a multi-point tapping touch event in a central area of a current window;
detect a continuous swipe motion beginning from the central area of the multi-point tapping touch event of the current window;
enlarge or shrinking the current window in response to the swipe motion;
if the swipe motion continues to within a threshold distance of the edge of another window, eliminating a divider at one edge of the current window; and
close a window of the multiple windows.

19. The electronic device of claim 14, wherein changes to a window occur visibly to a user as a multi-point touch event or a swipe motion occurs.

20. The electronic device of claim 14, wherein the at least two or more points comprising the points of contact of the new multi-point touch event are related by at least one of a threshold distance, contact time or pressure.
